(19) United States
(12) Patent Application Publication
(10) Pub. No.: US 2009/0327948 A1
(43) Pub. Date: Dec. 31, 2009

(54) TEXT INPUT

(75) Inventors: Merja Tuulikki Penttinen, Espoo (FI); Minna Karukka, Oulu (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/147,718

(22) Filed: Jun. 27, 2008

(51) Int. Cl. G06F 3/048

(52) U.S. Cl. 715/780

(57) ABSTRACT

A method for indicating an input language on a display. The method includes displaying an input indicator, associated with a character input application, the character input application being provided access to a plurality of input languages, each identified by a language code. Predetermined representations of the characters in the language code are associated with the input of a character format mode of the input language in the character input application, such that a character format mode of the input language is indicated by the language code displayed by means of the input indicator. A corresponding electronic apparatus, user interface and computer program product are also presented.

### TECHNICAL FIELD

The disclosed embodiments generally relates to the display of the language in use in character input applications such as text editors and more particularly to the display of character format mode.

### BACKGROUND

Handheld electronic devices are used in a variety of language settings and users can often find themselves writing text in multiple languages. For example, a user might reply to one e-mail message in English and to another in Finnish. At the same time the user switch frequently between different character format modes, for example, upper-case character format, lower-case character format, automatic switching between the two former modes, e.g. input of upper-case character format after punctuation mark only in automatic capitalization format mode, or text disambiguation mode. It is therefore advantageous to display both the input language and character format mode on the user interface for the user to get immediate feedback on the current input mode.

Previously the currently selected input language and character format mode are presented as separate indicators on the user interface. The current choice of input language may be indicated as a visual abbrevation indicator and another visual indicator may present information regarding other aspects of the current input mode, such whether a reduced-sized keyboard is currently in a lower-case letter entry mode or an upper-case letter entry mode. The indicators may be positioned towards the corner of the display and be of reduced size in order to minimize its obstruction of other user interface items.

A drawback with the previously known techniques is the increased gathering of information on the limited display area, as the density of useful information on the display must be improved to achieve a sufficient overview of the message text and provide space for additional status information and applications on the display of a handheld electronic apparatus, such as a mobile communication terminal. A further disadvantage from related art solutions is the reduced legibility following the efforts to minimize the size of obstructive display elements.

### SUMMARY

In view of the above, it would be desirable to achieve a method for indicating the current input language and character format mode on a display of an electronic apparatus.

It would also be desirable to achieve an electronic apparatus for indicating the current input language and character format mode on the display of the electronic apparatus.

It would also be desirable to achieve a user interface for indicating the current input language and character format mode on a display of an electronic apparatus.

It would also be desirable to achieve a computer program product for indicating the current input language and character format mode on a display of an electronic apparatus.

According to a first aspect of the disclosed embodiments there has been provided a method for indicating an input language on a display of an electronic apparatus comprising;

displaying an input indicator on the display, the input indicator being associated with a character input application,

providing the character input application access to a plurality of input languages each language having an associated language code, the language code comprises a sequence of characters,

displaying by means of the input indicator the sequence of characters identifying the language code for the input language accessed by the character input application,

associating one of a plurality of predetermined representations of characters in the sequence of characters with the input of one of a plurality of character format modes of the input language in the character input application, such that the one of a plurality of character format modes of the input language is indicated by the language code displayed by means of the input indicator. By associating a predetermined representation of the characters in the language code with a character format mode it is possible to get feed-back on the current character format mode used directly from the language code indicator. Accordingly, no separate indicator for the character format mode is necessary. This optimizes the use of available space on the display. Further, it is not required by the user to move focus between several indicators, as the most necessary information regarding the current input mode, i.e the character format mode and the input language, is available at the same location.

According to one embodiment the association of one of a plurality of predetermined representations of characters in the sequence of characters may involve displaying characters in the sequence of characters as upper-case, lower-case, underlined, bold, italic or any combination thereof such that the display of any first character may be different from the display of any second character in the sequence of characters. By displaying the characters in the language code in several different formats, i.e. predetermined representations, several different character format modes can be identified by the user, in that each predetermined representation is associated with a character format mode.

According to another embodiment the association of one of a plurality of predetermined representations of characters in the sequence of characters may involve;

displaying at least one character in the sequence of characters as upper-case for input of an upper-case character format mode in the character input application;

displaying at least one character in the sequence of characters as lower-case for input of a lower-case character format mode in the character input application;

displaying at least one character in the sequence of characters as upper-case and displaying at least one character in the sequence of characters as lower-case for input of upper-case character format mode after punctuation mark and input of lower-case character format mode after initial said upper-case character format mode input in the character input application,

displaying at least one character in the sequence of characters as upper-case, lower-case, underlined, bold, italic or any combination thereof for input of disambiguation character format mode in the character input application. The input of lower-case character format mode after an initial upper-case character format mode input in the character input application is known as automatic capitalization, i.e. an upper-case character following a punctuation mark and a lower-case character following this initial upper-case character. Several possible combinations may be used for the representation of a disambiguation mode, such as T9 text disambiguation or any other text disambiguation logic. Further, other representations of characters in the language code can be associated with other character format modes, for example, bold characters in the language code may be associated with input of bold characters in the character input application, italic representation of the characters in the language code may be associated with input of italic characters in the character input application, underlined characters in the language code may be associated with input of underlined characters in the character input application. Displaying the characters in the language code as a particular font type may be associated with the input of a character format mode where the characters in the character input application has the corresponding font type. Displaying the characters in the language code in a particular color may be associated with the input of a character format mode where the characters in the character input application has the corresponding color.

According to another embodiment the language code may be displayed as a sequence of at least two characters in the sequence of characters. Several different variations are possible regarding the number of characters in the language code. A shorter sequence of characters may be advantageous in order to save space. The characters in the sequence of characters may be any alpha-numerical character.

According to another embodiment there is provided input to the character input application is by means of an input device, the input provides a first selection and a second selection of a plurality of selections, associating the first selection with the one of a plurality of input languages and associating the second selection with the one of a plurality of predetermined representations of characters. The input from the input device may accordingly determine input language and character format mode. The input of a special character, that may be defined by the user, in the character input application may also automatically switch to another input language and/or to another character format mode. Likewise, depending on the contextual circumstances, the character input application may also automatically switch to another input language, for example, if a message text is received in Finnish and if a subsequent reply is made, the input language may switch from a current English setting to a Finnish setting when choosing the reply function in the character input application. The change of language may also occur automatically depending on the origin of the message, for example, the country code of the phone number of the sender of the message. The language may also be changed by holding a key while pressing any alpha-numerical key, for example the ‘def’ key in case of a ITU-T keypad, to present a selection menu of input languages, for example, starting with the letter “e” after pressing the alpha-numerical key ‘def’ two times.

According to a another embodiment the character input application may be associated with a text editor, e-mail program, messaging program, or any program receiving character input. The input indicator, displaying the language code and one of a plurality associated character format modes may accordingly be utilized for any character input application.

According to a another embodiment the input language is the language used for text disambiguation in input of a disambiguation character format mode in the character input application. This is advantageous in that a user may quickly identify by means of the input indicator the current language used for text disambiguation.

According to a second aspect of the disclosed embodiments there has been provided an electronic apparatus comprising a controller, a display and an input device, the controller being coupled to the display and the input device and being configured to provide a user interface for indicating an input language on the display, wherein;

the user interface is configured to display an input indicator on the display, the input indicator being associated with a character input application, the input device is configured to provide input to the character input application,

the controller is configured to provide the character input application access to a plurality of input languages each language having an associated language code, the language code comprises a sequence of characters,

the user interface is configured to display by means of the input indicator the sequence of characters identifying the language code for the input language accessed by the character input application,

the controller is configured to associate one of a plurality of predetermined representations of characters in the sequence of characters with the input of one of a plurality of character format modes of the input language in the character input application, such that the one of a plurality of character format modes of the input language is indicated by the language code displayed by means of the input indicator. By associating a predetermined representation of the characters in the language code with a character format mode is possible to get feed-back on the current character format mode used directly from the language code indicator.

According to one embodiment the user interface may be configured to present the one of a plurality of predetermined representations of characters in the sequence of characters by the display of characters in the sequence of characters as upper-case, lower-case, underlined, bold, italic or any combination thereof such that the display of any first character may be different from the display of any second character in the sequence of characters. By displaying the characters in the language code in several different formats, i.e. predetermined representations, several different character format modes can be identified by the user, in that each predetermined representation is associated with a character format mode.

According to another embodiment the user interface may be configured to indicate the one of a plurality of predetermined representations of characters in the sequence of characters by;

the display of at least one character in the sequence of characters as upper-case for input of upper-case character format mode in the character input application;

the display of at least one character in the sequence of characters as lower-case for input of lower-case character format mode in the character input application;

the display of at least one character in the sequence of characters as upper-case and the display of at least one character in the sequence of characters as lower-case for input of an upper-case character format mode after punctuation mark and input of lower-case character format mode after initial said upper-case character input in the character input application;

the display of at least one character in the sequence of characters as upper-case, lower-case, underlined, bold, italic or any combination thereof for input of disambiguation character format mode in the character input application. Several possible combinations may be used for the representation of a disambiguation mode, such as T9 text disambiguation or any other text disambiguation logic.

According to another embodiment the user interface may be configured to display the language code as a sequence of at least two characters in the sequence of characters.

According to another embodiment the input device is configured to provide input comprising of a first selection and a second selection of a plurality of selections, the controller associates the first selection with the one of a plurality of input languages and associates the second selection with the one of a plurality of predetermined representations of characters. The input from the input device may accordingly determine input language and character format mode.

According to another embodiment the controller may associate the character input application with a text editor, e-mail program, messaging program, or any program receiving character input.

According to another embodiment the input language is the language used for text disambiguation in input of a disambiguation character format mode in the character input application.

According to a further embodiment the electronic apparatus may comprise a mobile communication terminal.

According to a third aspect of the disclosed embodiments there has been provided a user interface embodied in an electronic apparatus for indicating an input language, the electronic apparatus having a controller, a display and an input device, wherein;

the user interface is configured to display an input indicator on the display, the input indicator being associated with a character input application, the input device is configured to provide input to the character input application;

the controller is configured to provide the character input application access to a plurality of input languages each language having an associated language code, the language code comprises a sequence of characters;

the user interface is configured to display by means of the the input indicator the sequence of characters identifying the language code for the input language accessed by the character input application;

the user controller is configured to associate one of a plurality of predetermined representations of characters in the sequence of characters with the input of one of a plurality of character format modes of the input language in the character input application, such that the one of a plurality of character format modes of the input language is indicated by the language code displayed by means of the input indicator.

According to a fourth aspect of the disclosed embodiments there has been provided a computer program product comprising software instructions that, when executed in a controller of a mobile communication terminal, performs the method according to the first aspect of the disclosed embodiments.

According to a fifth aspect of the disclosed embodiments there has been provided an electronic apparatus for indicating an input language on a display comprising;

means for displaying an input indicator on the display, the input indicator being associated with a character input application;

means for providing input to the character input application;

means for providing the character input application access to a plurality of input languages each language having an associated language code, the language code comprises a sequence of characters;

means for displaying on the input indicator the sequence of characters identifying the language code for the input language accessed by the character input application;

means for associating one of a plurality of predetermined representations of characters in the sequence of characters with the input of one of a plurality of character format modes of the input language in the character input application, such that the one of a plurality of character format modes of the input language is indicated by the language code displayed on the input indicator.

Any feature of the first aspect may be applied to the second, and/or third, and/or fourth, and/or fifth aspects.

Other objectives, features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments of the present invention will now be described in more detail, reference being made to the enclosed drawings, in which:

FIG. 1 is a schematic illustration of a cellular telecommunication system, as an example of an environment in which the disclosed embodiments may be applied.

FIG. 2 is a schematic front view illustrating a mobile communication terminal according to a first embodiment of the present invention.

FIG. 3 is a schematic front view illustrating a mobile communication terminal according to a second embodiment of the present invention.

FIG. 4 illustrates a typical display layout for presentment of a character input format according to previously known techniques.

FIG. 5 is a schematic block diagram representing an internal component, software and protocol structure of the mobile communication terminal shown in FIG. 2 and FIG. 3.

FIG. 6 illustrates a schematic screen view of a user interface that can be embodied in the mobile communication terminal of FIG. 2 and FIG. 3.

FIGS. 7a-c illustrate schematic screen views of a user interface that can be embodied in the mobile communication terminal of FIG. 2 and FIG. 3.

FIGS. 8a-b are flow charts illustrating methods according to embodiments of the present invention that can be executed in the mobile communication terminal of FIG. 2 and FIG. 3.

### DETAILED DESCRIPTION OF EMBODIMENTS

The disclosed embodiments will now be described more fully hereinafter with reference to the accompanying drawings, in which certain embodiments are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

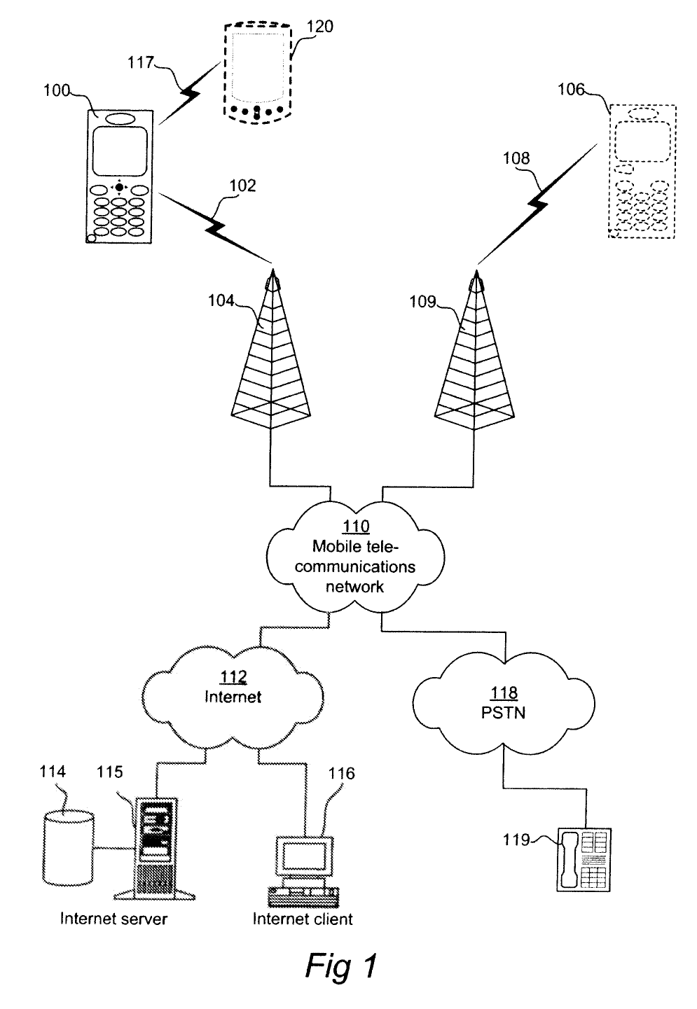

FIG. 1 illustrates an example of a cellular telecommunications system in which the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile communication terminal 100 according to the disclosed embodiments and other devices, such as another mobile communication terminal 106, a PDA 120 or a stationary telephone 119. It is to be noted that for different embodiments of the mobile communication terminal 100 and in different situations, different ones of the telecommunications services referred to above may or may not be available; the invention is not limited to any particular set of services in this respect.

The mobile communication terminals 100, 106 may be connected to a mobile telecommunications network 110 through radio frequency (RF) links 102, 108 via base stations 104, 109. The mobile telecommunications network 110 may be in compliance with any commercially available mobile telecommunications standard, such as Global System Mobile (GSM), Universal Mobile Telecommunications System (UMTS), Digital-Advanced Mobile Phone Service (D-AMPS), Code Division Multiple Access2000 (CDMA2000), (Freedom of Mobile Multimedia Access) FOMA and Time Division-Synchronous Code Division Multiple Access (TD-SCDMA). The mobile telecommunications network 110 is operatively connected to a wide area network 112, which may be Internet or a part thereof. A server 115 has a data storage 114 and is connected to the wide area network 112, as is an Internet client computer 116.

A public switched telephone network (PSTN) 118 is connected to the mobile telecommunications network 110 in a familiar manner. Various telephone terminals, including the stationary telephone 119, are connected to the PSTN 118.

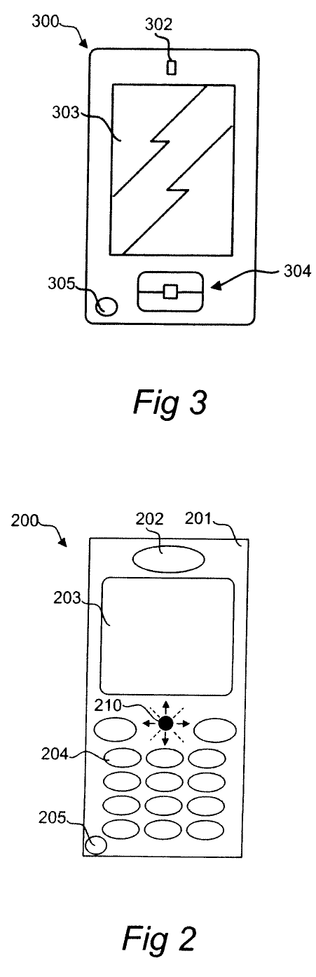

A first embodiment 200 of the mobile communication terminal 100 is illustrated in more detail in FIG. 2. The mobile communication terminal 200 comprises an apparatus housing 201, a loudspeaker 202, a display 203, a microphone 205, and an input device such as a set of keys 204, which may include a keypad of common ITU-T type (alpha-numerical keypad), a multi-way input device 210 in the form of a joystick or navigation keys.

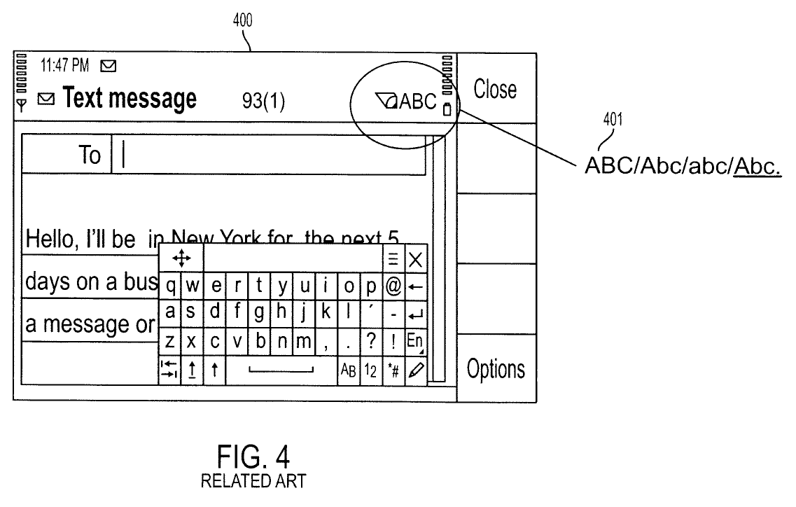

A second embodiment 300 of the mobile communication terminal 100 is illustrated in more detail in FIG. 3. The mobile communication terminal 300 comprises a speaker or earphone 302, and an input device such as a set of keys 304. The input device may also comprise a touch-sensitive display 303, and a microphone 305 for input of speech to a speech recognition software.

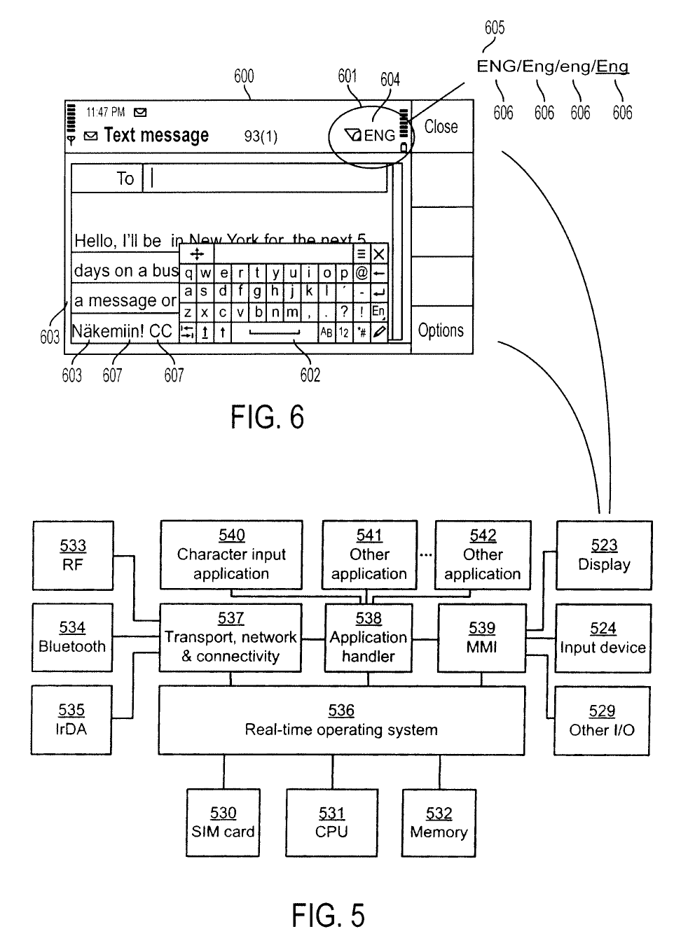

In addition, but not shown in FIG. 2 and FIG. 3, the mobile communication terminal 200/300 comprises various internal components, the more important of which are illustrated in FIG. 5.

FIG. 4 illustrates a typical display layout 400 for presentment of a character input format according to previously known techniques. The input format is indicated by a letter sequence 401, typically one of ‘ABC’, ‘Abc’, ‘abc’, ‘Abc’ depending on what character format the user which to input.

The internal component, software and protocol structure of a mobile communication terminal 200/300 according to one embodiment, will now be described with reference to FIG. 5.

The mobile communication terminal has a controller 531 which is responsible for the overall operation of the mobile communication terminal and is preferably implemented by any commercially available CPU (“Central Processing Unit”), DSP (“Digital Signal Processor”) or any other electronic programmable logic device. The controller 531 has associated electronic memory 532 such as RAM memory, ROM memory, EEPROM memory, flash memory, hard drive, optical storage or any combination thereof. The memory 532 is used for various purposes by the controller 531, one of them being for storing data and program instructions for various software in the mobile communication terminal. The data may include a plurality of input languages, which are accessible to a character input application 540.

The software includes a real-time operating system 536, drivers for a man-machine interface (MMI) 539, an application handler 538 as well as various applications.

The applications include aforethe character input application 540, as well as various other applications 541/542, such as a contacts (phonebook) application, a messaging application, a calendar application, applications for voice calling, video calling, speech recognition, web browsing, media player, document reading and/or document editing, a camera application, one or more video games, a notepad application etc.

The MMI 539 also includes one or more hardware controllers, which together with the MMI drivers cooperate with the display 523, which may be identical to the display 203/303 of FIG. 2/FIG. 3, input device 524, which may be identical to the input device 203/204 of FIG. 2 or to the input device 303/304 of FIG. 3, as well as various other I/O devices 529 such as microphone, speaker, vibrator, ringtone generator, LED indicator, camera etc. As is commonly known, the user may operate the mobile communication terminal through the man-machine interface thus formed, which in the disclosed embodiment is of the very common kind known as GUI (graphical user interface).

The software also includes various modules, protocol stacks, drivers, etc., which are commonly designated as 537 and which provide communication services (such as transport, network and connectivity) for an RF interface 533, and optionally a Bluetooth interface 534 and/or an IrDA interface 535 for local connectivity. The RF interface 533 comprises an internal or external antenna as well as appropriate radio circuitry for establishing and maintaining a wireless link to a base station (e.g., the link 102 and base station 104 in FIG. 1). As is well known to a person skilled in the art, the radio circuitry comprises a series of analogue and digital electronic components, together forming a radio receiver and transmitter. These components include, i.e., band pass filters, amplifiers, mixers, local oscillators, low pass filters, AD/DA converters, etc. The mobile communication terminal may be provided with other wireless interfaces than the ones mentioned above, including but not limited to WLAN and HomeRF. Any one of such other wireless interfaces, or aforementioned optional interfaces, may be used for establishing and communicating over the wireless link 117 to the nearby device 120 of FIG. 1.

The mobile communication terminal also has a SIM card 530 and an associated reader. As is commonly known, the SIM card 530 comprises a processor as well as local work and data memory.

FIG. 6 illustrates a display 600 of the character input application 602 when used for text input on the mobile communication terminal's display 523/303/203.

The display 600 has an input indicator 601 which is associated with the character input application 602. The input indicator 601 will accordingly reflect the status of the character input application 602 and the input as described below. The input to the character input application 602 is provided by the input device 524. For example, a touch sensitive display 303 may be used for input of characters to the character input application 602 in FIG. 6. The character input application 602 may also access a plurality of input languages 603 that may be stored in the memory 532 and provided access to by the controller 531. Each input language 603 has an associated language code 604 that identifies the language. The language code 604 comprises a sequence of characters 605 that may correspond to an aberration of the currently selected input language 603. Several alternative language codes 604 may be available for each input language 603, comprising different numbers of characters, e.g. if the character input application 602 has current access to English as the input language 603, the sequence of characters 605 in the language code 604 may be: ‘en’, ‘eng’, ‘engl’, ‘engli’, ‘englis’ or ‘english’, if the user has chosen to display the input language 603 in the English language. The sequence of characters 605 identifying the language code 604 is displayed by the input indicator 601. It may be advantageous to have a shorter aberration of the input language 603 as the input indicator 601 occupies less space for a shorter sequence of characters 605.

The controller 531 associates one of a plurality of predetermined representations of characters 606 in the sequence of characters 605 with the input of one of a plurality of character format modes 607 of the input language 603 in the character input application 602. Thus for a current language code 604 having a particular sequence of characters 605 several predetermined representations 606 may be available, in that the characters are represented in a plurality of ways, while the order between the characters in the sequence of characters 605 is maintained. Each representation is associated with a character format mode 607 of the input language 603. A plurality of character format modes 607 of the current input language 603 are accordingly achieved by the plurality of predetermined representations of characters 606 in the sequence of characters 605. The input indicator 601 displays the sequence of characters 605 identifying the language code 604. The input indicator 601 displays accordingly a plurality of predetermined representations of characters 606 in the sequence of characters 605, each predetermined representation 606 being associated with the input of one of a plurality of character format modes 607. The one of a plurality of character format modes 607 is accordingly being indicated by the language code 604 displayed by means of the input indicator 601.

Predetermined should in this context be construed as each representation of characters 606 in the sequence of characters 605 has an associated character format mode 607 of the current input language 603, in that the character format mode 607 for each representation characters 606 in the sequence of characters 605 is known.

The plurality of predetermined representations of characters 606 in the sequence of characters 605 may involve the display of characters in the sequence as upper-case, lower-case, underlined, bold, italic, or any other character representation, or any combination thereof, such that the display of any first character in the sequence of characters 605 may be different from the display of any second character in the sequence of characters 605.

For example, for a language code 604 “eng” for a current English input language 603 in the character input application 602, the different representations of characters 606 in the sequence of characters 605 “eng”, may accordingly be displayed as; “eng”, “Eng”, “ENG”, “Eng”, “eng”, “eng”, “Eng”, “Eng”, or any other combination of character representations 606. Each of these previous examples of representations of characters 606 in the sequence of characters 605 are associated with a corresponding character format mode 607 of the current input language 603. For example, the display of at least one character in the sequence of characters 605 as upper-case may be associated with input of an upper-case character format mode 607 in the character input application 602. For the upper-case character format mode 607 the character input application 602 generates upper-case characters in response to input from an input device 524, such as a set of keys 204/304, a multi-way input device 210, a touch screen display 303, a microphone 205/305 or any other input device capable of providing input to a character input application 602. Further, the display of at least one character in the sequence of characters 605 as lower-case may be associated with input of a lower-case character format mode 607 in the character input application 602. The display of at least one character in the sequence of characters 605 as upper-case together with the display of at least one character in the sequence of characters 605 as lower-case may be associated with the input of an upper-case character format mode 607 after punctuation mark and input of lower-case character format mode 607 after the initial input of an upper-case character in the character input application 602, commonly known as automatic character capitalization after punctuation mark, referred to as auto-capitalization character format mode 607. Several other character format modes 607 may be associated with the plurality of predetermined representations of characters 606. For instance, the use of text disambiguation, such as T9 logic, referred to as disambiguation character format mode 607 or T9 character format mode 607, may be associated with the display of at least one character in the sequence of characters 605 as underlined, bold, italic or any other predetermined representation of characters 606. In case no input language 603 is selected, the input indicator 601 may display an arbitrary sequence of character 605, such as “abc”. In one embodiment, the sequence of characters 605 identifying the language code 604 may only be displayed by the input indicator if the disambiguation logic is used, that is, if the disambiguation character format mode is active. If the disambiguation logic is not used an arbitrary sequence of character 605, such as “abc” may be displayed by the input indicator 601. Likewise, the display of the language code 604 may be associated with the disambiguation character format mode 607, such that the input language 603, associated with the language code 604, is the current language the disambiguation logic uses for text disambiguation.

Table 1 show two examples of input languages, English (1) and Finnish (2) among a plurality of input languages (N), and the associated language codes Eng (1.1), En (1.2), and Fin (2.1), Fi (2.2) among a plurality of languages codes (1.M) and (2.M), respectively. The sequence of characters in the language code Fin (2.1), as an example, has the predetermined representations of characters FIN (2.1.1), fin (2.1.2), Fin (2.1.3), and Fin (2.1.4), among a plurality of predetermined representations of characters (2.1.X), each of which are associated with a character format mode, for example, FIN (2.1.1) being associated with an upper-case character format mode in the character input application.

TABLE 1

| | | Predetermined | |
|---|---|---|---|
| Input | | representation | Character format |
| language | language code | of characters | mode |
| 1. English | 1.1 Eng | 1.1.1 ENG | upper-case |
| | | 1.1.2 eng | lower-case |
| | | 1.1.3 Eng | auto capitalization |
| | | 1.1.4 Eng | T9 |
| | | 1.1.X . . . | . . . |
| | 1.2 En | 1.1.1 EN | upper-case |
| | | 1.1.2 en | lower-case |
| | | 1.1.3 En | auto capitalization |
| | | 1.1.4 En | T9 |
| | | 1.1.X . . . | . . . |
| | 1.M . . . | . . . | . . . |
| 2. Finnish | 2.1 Fin | 2.1.1 FIN | upper-case |
| | | 2.1.2 fin | lower-case |
| | | 2.1.3 Fin | auto capitalization |
| | | 2.1.4 Fin | T9 |
| | | 2.1.X . . . | . . . |
| | 2.2 Fi | 2.1.1 FI | upper-case |
| | | 2.1.2 fi | lower-case |
| | | 2.1.3 Fi | auto capitalization |
| | | 2.1.4 Fi | T9 |
| | | 2.1.X . . . | . . . |
| | 2.M . . . | . . . | . . . |
| N. . . . | . . . | . . . | . . . |

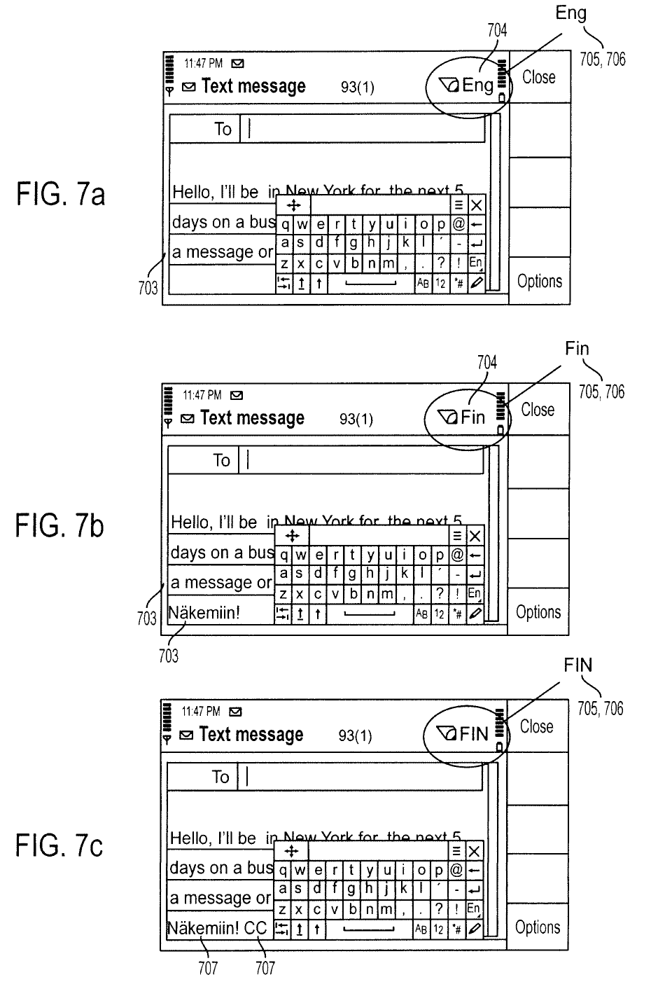

FIGS. 7a-c illustrate schematic screen views of a user interface that can be embodied in the mobile communication terminal of FIG. 2 and FIG. 3. In FIG. 7a the input indicator displays the language code 704 “Eng” for English as the input language 703, illustrated by a message text in English. Following the example in Table 1, at least one character in the sequence of characters 705 in the English language code 704 is displayed as upper-case and at least one character in the sequence of characters 705 is displayed as lower-case, the associated character format mode to this predetermined representation 706 of characters is auto-capitalization.

In FIG. 7b the user of the character input application has selected Finnish as the input language 703 as indicated by the language code 704 “Fin” by means of the input indicator. The current Finnish input language 703 is exemplified by a message text in Finnish following the previous English input language 703. The representation of the characters 706 in the language code 704 indicates that the character format mode is the same as in FIG. 7a, that is auto-capitalization, in that at least one character is displayed as upper-case and at least one character in the current sequence of characters 705, “Fin”, is displayed as lower-case.

In FIG. 7c the user has selected a different representation of the characters 706 in the language code, “FIN”, such that at least one character in the sequence of characters 705 is displayed as upper-case, and following the example in Table 1, the associated character format mode 707 is upper-case, exemplified by a message text with upper case characters in the character input application, following the previous auto-capitalization character format mode 707. The input language is the same as in FIG. 7b as the sequence of characters 705 is not changed, that is, the representation “Fin” and “FIN” has the same sequence of characters 705.

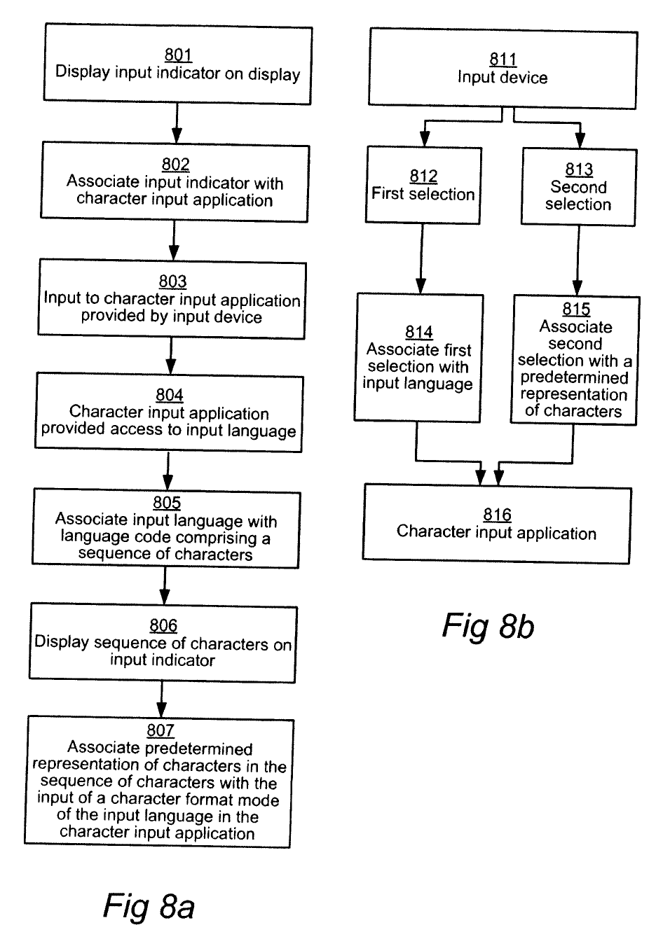

FIG. 8a is a flow chart illustrating a method according to an embodiment that can be executed in the mobile communication terminal of FIG. 2 and FIG. 3. An input indicator is displayed on a display 801 of a mobile communication terminal. The input indicator is associated with a character input application in the mobile communication terminal 802. An input device provides input to the character input application 803. The character input application is provided access to a plurality of input languages that may be loaded in a memory of the mobile communication terminal 804. The input language is associated with a language code, which comprises a sequence of characters 805. The sequence of characters identifying the language code for the input language is displayed by means of the input indicator 806. A predetermined representation of the characters in the sequence of characters is associated with the input of one of a plurality of character format modes of the input language in the character input application, such that the one of a plurality of character format modes of the input language is indicated by the language code 807. The association of one of a plurality of predetermined representations of characters in the sequence of characters may involve displaying characters in the sequence of characters as upper-case, lower-case, underlined, bold, italic or any combination thereof such that the display of any first character may be different from the display of any second character in the sequence of characters. By displaying the characters in the language code in several different formats, i.e. predetermined representations, several different character format modes can be identified by the user of the mobile communication terminal, in that each predetermined representation is associated with a character format mode.

FIG. 8b is a flow chart illustrating a method according to an embodiment that can be executed in the mobile communication terminal of FIG. 2 and FIG. 3. An input device 811 provides input to the character input application 816, the input comprise a first selection 812 and a second selection 813 among a plurality of selections. The first and second selection 812, 813, may be provided by a user of the character input application 816 in response to the user pressing a first key and a second key, in that the input device 811 comprises a set of keys, or in response to the user pressing a first and a second touch sensitive area or a first and second display item on a display menu, such as a pop-up menu, in that the input device 811 comprises a touch sensitive display, or in response to the user actuating the microphone for receiving a first and second speech command for speech recognition. The first and second selection 812, 813, may also be provided by, for example, the user pressing a key or touch sensitive area for different durations of time, for example, a short press or actuation provides a first selection 812 and a long press or actuation provides a second selection 813. A controller may associate the first selection 812 with one of a plurality of input languages 814 and further associate the second selection 813 with one of a plurality of predetermined representations of characters 815. The user may accordingly select the desired input language and the character format mode associated with the predetermined representation of characters in the language code.

Although the invention has above been described using an embodiment in a mobile communication terminal, the invention is applicable to any type of portable apparatus capable indicating input language and character format mode, including pocket computers, portable gaming devices, cameras, lap-top computers, desktop computers etc.

The invention has mainly been described above with reference to a few embodiments. However, as is readily appreciated by a person skilled in the art, other embodiments than the ones disclosed above are equally possible within the scope of the invention, as defined by the appended patent claims.

1. A method comprising:
indicating an input language on a display of an electronic apparatus by;
displaying an input indicator on the display, the input indicator being associated with a character input application;
providing the character input application access to a plurality of input languages each language having an associated language code, the language code comprises a sequence of characters;
displaying by means of the input indicator the sequence of characters identifying the language code for the input language accessed by the character input application;
associating one of a plurality of predetermined representations of characters in the sequence of characters with the input of one of a plurality of character format modes of the input language in the character input application, such that the one of a plurality of character format modes of the input language is indicated by the language code displayed by means of the input indicator.

2. Method according to claim 1 wherein the association of one of a plurality of predetermined representations of characters in the sequence of characters involves displaying characters in the sequence of characters as upper-case, lower-case, underlined, bold, italic or any combination thereof such that the display of any first character may be different from the display of any second character in the sequence of characters.

3. Method according to claim 2 wherein the association of one of a plurality of predetermined representations of characters in the sequence of characters involves;
displaying at least one character in the sequence of characters as upper-case for input of an upper-case character format mode in the character input application;
displaying at least one character in the sequence of characters as lower-case for input of a lower-case character format mode in the character input application;
displaying at least one character in the sequence of characters as upper-case and displaying at least one character in the sequence of characters as lower-case for input of upper-case character format mode after punctuation mark and input of lower-case character format mode after initial said upper-case character format mode input in the character input application;
displaying at least one character in the sequence of characters as upper-case, lower-case, underlined, bold, italic or any combination thereof for input of a disambiguation character format mode in the character input application.

4. Method according to claim 1 comprising displaying the language code as a sequence of at least two characters in the sequence of characters.

5. Method according to claim 1 comprising providing input to the character input application by means of an input device, the input comprises a first selection and a second selection of a plurality of selections, associating the first selection with the one of a plurality of input languages and associating the second selection with the one of a plurality of predetermined representations of characters.

6. Method according to claim 1 comprising associating the character input application with a text editor, e-mail program, messaging program, or any program receiving character input.

7. Method according to claim 1 wherein the input language is the language used for text disambiguation in input of a disambiguation character format mode in the character input application.

8. An electronic apparatus comprising:
a controller, a display and an input device, the controller being coupled to the display and the input device and being configured to provide a user interface for indicating an input language on the display, wherein;
the user interface is configured to display an input indicator on the display, the input indicator being associated with a character input application, the input device is configured to provide input to the character input application;
the controller is configured to provide the character input application access to a plurality of input languages each language having an associated language code, the language code comprises a sequence of characters;
the user interface is configured to display by means of the input indicator the sequence of characters identifying the language code for the input language accessed by the character input application;
the controller is configured to associate one of a plurality of predetermined representations of characters in the sequence of characters with the input of one of a plurality of character format modes of the input language in the character input application, such that the one of a plurality of character format modes of the input language is indicated by the language code displayed by means of the input indicator.

9. An electronic apparatus according to claim 8 wherein the user interface is configured to indicate the one of a plurality of predetermined representations of characters in the sequence of characters by the display of characters in the sequence of characters as upper-case, lower-case, underlined, bold, italic or any combination thereof such that the display of any first character may be different from the display of any second character in the sequence of characters.

10. An electronic apparatus according to claim 9 wherein the user interface is configured to indicate the one of a plurality of predetermined representations of characters in the sequence of characters by;
the display of at least one character in the sequence of characters as upper-case for input of upper-case character format mode in the character input application;
the display of at least one character in the sequence of characters as lower-case for input of lower-case character format mode in the character input application;
the display of at least one character in the sequence of characters as upper-case and the display of at least one character in the sequence of characters as lower-case for input of upper-case character format mode after punctuation mark and input of lower-case character format mode after initial said upper-case character format mode input in the character input application;
the display of at least one character in the sequence of characters as upper-case, lower-case, underlined, bold, italic or any combination thereof for input of disambiguation character format mode in the character input application.

11. An electronic apparatus according to claim 8 wherein the user interface is configured to display the language code as a sequence of at least two characters in the sequence of characters.

12. An electronic apparatus according to claim 8 wherein the input device is configured to provide input comprising of a first selection and a second selection of a plurality of selections, the controller associates the first selection with the one of a plurality of input languages and associates the second selection with the one of a plurality of predetermined representations of characters.

13. An electronic apparatus according to claim 8 wherein the controller associates the character input application with a text editor, e-mail program, messaging program, or any program receiving character input.

14. An electronic apparatus according to claim 8 wherein the input language is the language used for text disambiguation in input of a disambiguation character format mode in the character input application.

15. An electronic apparatus according to claim 8 comprising a mobile communication terminal.

16. A user interface embodied in an electronic apparatus for indicating an input language, the electronic apparatus having a controller, a display and an input device, wherein;
the user interface is configured to display an input indicator on the display, the input indicator being associated with a character input application, the input device is configured to provide input to the character input application;
the controller is configured to provide the character input application access to a plurality of input languages each language having an associated language code, the language code comprises a sequence of characters;
the user interface is configured to display by means of the input indicator the sequence of characters identifying the language code for the input language accessed by the character input application;
the controller is configured to associate one of a plurality of predetermined representations of characters in the sequence of characters with the input of one of a plurality of character format modes of the input language in the character input application, such that the one of a plurality of character format modes of the input language is indicated by the language code displayed by means of the input indicator.

17. A computer program product comprising software instructions that, when executed in a controller of a mobile communication terminal, performs the method according to claim 1.

18. An electronic apparatus for indicating an input language on a display comprising;
means for displaying an input indicator on the display, the input indicator being associated with a character input application;
means for providing input to the character input application;
means for providing the character input application access to a plurality of input languages each language having an associated language code, the language code comprises a sequence of characters;
means for displaying on the input indicator the sequence of characters identifying the language code for the input language accessed by the character input application;
means for associating one of a plurality of predetermined representations of characters in the sequence of characters with the input of one of a plurality of character format modes of the input language in the character input application, such that the one of a plurality of character format modes of the input language is indicated by the language code displayed on the input indicator.
